(19) United States
(12) Patent Application Publication
(10) Pub. No.: US 2016/0255040 A1
(43) Pub. Date: Sep. 1, 2016

(54) Method and System for Automatic E-mail Aliasing for User Anonymization

(71) Applicant: MasterCard International Incorporated, Purchase, NY (US)

(72) Inventor: Justin X. HOWE, San Francisco, CA (US)

(73) Assignee: MASTERCARD INTERNATIONAL INCORPORATED, Purchase, NY (US)

(21) Appl. No.: 14/632,473

(22) Filed: Feb. 26, 2015

(51) Int. Cl. H04L 12/58; H04L 29/08

(52) U.S. Cl. CPC H04L 51/36; H04L 67/306; H04L 51/28

(57) ABSTRACT

A method for identifying violative e-mails using aliasing includes: storing an e-mail profile, the profile including data related to an e-mail address; receiving e-mail registration information, the information including an alias e-mail address associated with the related e-mail address and an authorized entity; storing, in the e-mail profile, the alias e-mail address and the authorized entity; receiving an e-mail message, the message including data indicating the alias e-mail address as a recipient and a delivering entity as an author or sender; and processing the e-mail message, wherein the processing includes transmitting the e-mail message to the related e-mail address if the delivering entity is associated with the authorized entity, or identifying a merchant associated with the delivering entity as being in violation of one or more rules or regulations regarding the usage and collection of e-mail addresses.

### FIELD

The present disclosure relates to the use of e-mail aliases, specifically automatically generating and utilizing e-mail aliases to identify merchants in violation of rules and regulations regarding the distribution of e-mail messages.

### BACKGROUND

As technology becomes more and more integrated with the daily lives of people, the use of e-mail to send and receive correspondence and other messages becomes more and more widespread. E-mail can be a valuable tool for consumers, merchants, service providers, friends, family, and any manner of entity to reach out and communicate with others. However, the easy and efficient nature of e-mail also makes it susceptible to abuse. Rules and regulations are often adopted by regulatory entities, such as governments, in an attempt to stop nefarious parties from abusing e-mail. Nonetheless, some merchants and other entities still distribute unauthorized e-mails to users in direct violation of these regulations.

Unfortunately, identification of entities involved in the distribution of unauthorized e-mails can be exceedingly difficult. Many e-mail services often develop or utilize tools designed to identify and filter out unauthorized and/or “spam” e-mail messages, such as by identifying known senders of unauthorized messages and reviewing header or message data for indications of unauthorized activity. While these services and tools can often provide the end user with freedom from many unauthorized messages, such tools often fail to identify unauthorized e-mails that are sent to the user that are not spam, but are instead the result of unauthorized collection or use of the user's e-mail address. In addition, these tools often are designed to protect the end user, and provide no ability for identification of the parties involved in the distribution of the unauthorized messages.

Thus, there is a need for a technical solution to help protect users from receiving unauthorized e-mails, particularly in instances where an e-mail may not be considered spam, but instead may be unsolicited, and also for the identification of violative e-mails and the entities involved in their creation and distribution.

### SUMMARY

The present disclosure provides a description of systems and methods for identifying violative e-mails and generating and submitting e-mail aliases.

A method for identifying violative e-mails using aliasing includes: storing, in a profile database, an e-mail profile, wherein the e-mail profile includes data related to an e-mail address including at least the related e-mail address; receiving, by a receiving device, e-mail registration information, wherein the e-mail registration information includes at least an alias e-mail address associated with the related e-mail address and an authorized entity; storing, in the e-mail profile in the profile database, the received alias e-mail address and the authorized entity; receiving, by the receiving device, an e-mail message, wherein the e-mail message includes data indicating the alias e-mail address as a recipient and indicating a delivering entity as an author or sender; and processing, by a processing device, the received e-mail message, wherein the processing includes transmitting, by a transmitting device, the received e-mail message to the related e-mail address if the delivering entity is associated with the authorized entity, or identifying, by the processing device, a merchant associated with the delivering entity as being in violation of one or more rules or regulations regarding the usage and collection of e-mail addresses.

A method for automatic submission of an alias e-mail address includes: storing, in a profile database, an e-mail profile, wherein the e-mail profile includes data related to an e-mail address including at least the related e-mail address; receiving, by a receiving device, web page data for a web page, wherein the web page data includes a form comprised of at least one or more form fields, the one or more form fields including an e-mail field; automatically identifying, by a processing device, an alias e-mail address; submitting, by a transmitting device, the form included in the web page data, wherein the e-mail field included in the one or more form fields includes the identified alias e-mail address; and transmitting, by the transmitting device, at least the related e-mail address and alias e-mail address.

A system for identifying violative e-mails using aliasing includes a transmitting device, a profile database, a receiving device, and a processing device. The profile database is configured to store an e-mail profile, wherein the e-mail profile includes data related to an e-mail address including at least the related e-mail address. The receiving device is configured to receive e-mail registration information, wherein the e-mail registration information includes at least an alias e-mail address associated with the related e-mail address and an authorized entity. The processing device is configured to store, in the e-mail profile in the profile database, the received alias e-mail address and the authorized entity. The receiving device is further configured to receive an e-mail message, wherein the e-mail message includes data indicating the alias e-mail address as a recipient and indicating a delivering entity as an author or sender. The processing device is further configured to process the received e-mail message, wherein the processing includes: transmitting, by the transmitting device, the received e-mail message to the related e-mail address if the delivering entity is associated with the authorized entity; or identifying, by the processing device, a merchant associated with the delivering entity as being in violation of one or more rules or regulations regarding the usage and collection of e-mail addresses.

A system for automatic submission of an alias e-mail address includes a profile database, a receiving device, a processing device, and a transmitting device. The profile database is configured to store an e-mail profile, wherein the e-mail profile includes data related to an e-mail address including at least the related e-mail address. The receiving device is configured to receive web page data for a web page, wherein the web page data includes a form comprised of at least one or more form fields, the one or more form fields including an e-mail field. The processing device is configured to automatically identify an alias e-mail address. The transmitting device is configured to: submit the form included in the web page data, wherein the e-mail field included in the one or more form fields includes the identified alias e-mail address; and transmit at least the related e-mail address and alias e-mail address.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for managing e-mail addresses and aliases and identifying violative messages and merchants in accordance with exemplary embodiments.

FIG. 2 is a block diagram illustrating the processing server of FIG. 1 for managing e-mail addresses and aliases and identifying violative messages and merchants in accordance with exemplary embodiments.

FIG. 3 is a flow diagram illustrating a process for validating authorized e-mails in an e-mail distribution list in the system of FIG. 1 in accordance with exemplary embodiments.

FIG. 4 is a flow diagram illustrating a process for identifying a violative merchant using the system of FIG. 1 in accordance with exemplary embodiments.

FIG. 5 is a flow diagram illustrating a process for generating an alias e-mail address and processing of messages sent thereto in the system of FIG. 1 in accordance with exemplary embodiments.

FIG. 6 is a flow diagram illustrating a process for automatically generating alias e-mail addresses for a webpage using the processing server of FIG. 2 in accordance with exemplary embodiments.

FIG. 7 is a flow chart illustrating an exemplary method for moderating an e-mail distribution list in accordance with exemplary embodiments.

FIG. 8 is a flow chart illustrating an exemplary method for identifying high risk merchants in accordance with exemplary embodiments.

FIG. 9 is a flow chart illustrating an exemplary method for identifying violative e-mails using aliasing in accordance with exemplary embodiments.

FIG. 10 is a flow chart illustrating an exemplary method for automatic submission of an alias e-mail address in accordance with exemplary embodiments.

FIG. 11 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

### System for Managing E-mail Distribution and Identifying Violative Merchants

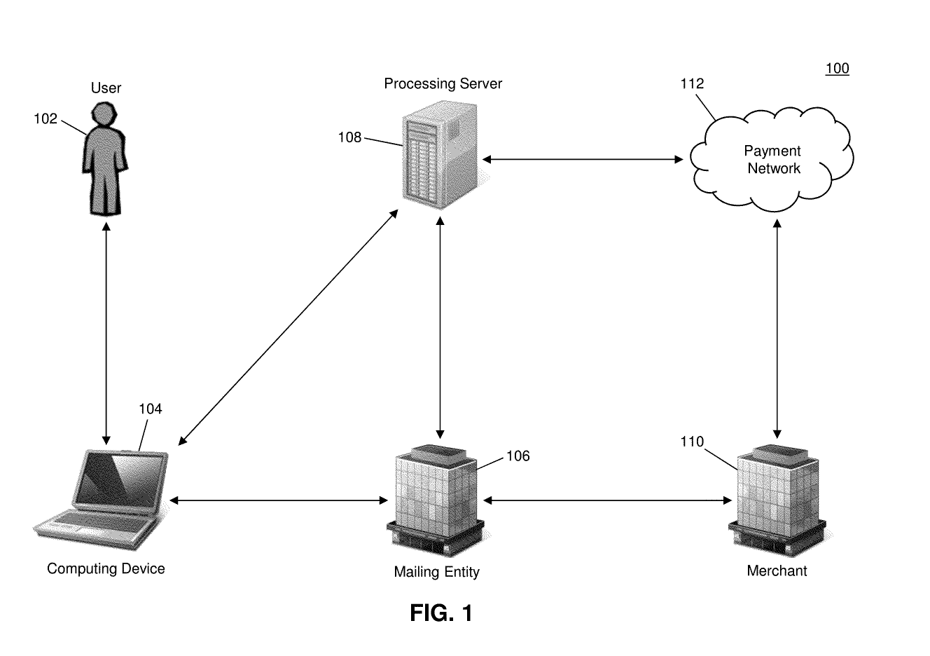

FIG. 1 illustrates a system 100 for the management of e-mail distribution lists and alias e-mail addresses and the identification of unauthorized e-mails and merchants associated with the creation and distribution thereof.

In the system 100, a user 102 may use a computing device 104 to access send and receive e-mail. The computing device 104 may be any type of computing device suitable for performing the functions disclosed herein, such as a desktop computer, laptop computer, notebook computer, tablet computer, cellular phone, smart phone, personal digital assistant, smart television, wearable computing device, embedded computing device, etc. The computing device 104 may be configured to communicate with a mailing entity 106 to send and receive e-mail messages. The mailing entity 106 as discussed herein may be an entity configured to send, receive, forward, or otherwise distribute e-mail messages, or may be an entity that creates or otherwise generates e-mail messages for sending via a mailing service.

The system 100 may also include a processing server 108. The processing server 108, discussed in more detail below, may be configured to moderate e-mail distribution lists for the mailing entity 106, identify unauthorized e-mail messages and their authors and/or distributors, generate aliases for the user 102, and perform additional functions as discussed herein. The processing server 108 may be configured to communicate with the computing device 104 and the mailing entity 106 using suitable protocols and networks, such as the Internet, a cellular communication network, Wi-Fi, etc.

The user 102 may, using the computing device 104, provide e-mail settings and information to the processing server 108, including information regarding authorized senders. The user 102 may, such as via an application program on the computing device 104, a website, or other suitable method, provide e-mail permission data to the processing server 108, such as data regarding restrictions on sharing for various mailing entities 106 or message originators or distributors. For instance, the user 102 may identify a merchant 110 with whom the user 102 has an account. As part of the account, the user 102 may specify that the merchant 110 is not allowed to share the user's e-mail address, or may set specific limitations on the sharing of the user's e-mail address (e.g., for partner merchants, for affiliated merchants, for subsidiary merchants, etc.). The user 102 may submit to the processing server 108 the merchant 110 and the corresponding limitation on sharing.

The processing server 108 may store the information for the user 102 for the merchant 110 and any other entities with whom the user 102 has specified a limitation on sharing, as well as similar data for other users, and may use it to validate e-mail distribution lists for mailing entities 106. For example, the mailing entity 106 may provide a list of e-mail addresses to the processing server 108 along with the source of the e-mail address, such as specifying the merchant 110 that provided the e-mail address. In some instances, the mailing entity 106 may also provide the purpose of the distribution list (e.g., advertisements, offers, newsletters, etc.).

The processing server 108 may receive the list and may validate e-mail addresses on the list based on the user-provided data. For example, if a first user 102 specified that the merchant 110 is not allowed to share their e-mail address, and a second user 102 specified that the merchant 110 is allowed to share their e-mail address to partner merchants, and the e-mail distribution list is for a partner merchant to the merchant 110, the processing server 108 may identify that the e-mail address for the first user 102 is not authorized to be on the list, but that the e-mail address for the second user 102 is authorized. The mailing entity 106 may then remove the e-mail address for the first user 102 before distributing any e-mails, which may protect the mailing entity from the unauthorized distribution of e-mail, which may be against various rules or regulations that may be applicable to the distribution (e.g., based on location of the computing device 104, the mailing entity 106, the partner merchant, etc.).

In some instances, the processing server 108 may be configured to identify entities responsible for the unauthorized sharing and/or use of an e-mail address, such as the merchant 110 in the above example that shared the first user's e-mail address against the wishes of the first user 102. The processing server 108 may be configured to communicate with a regulatory entity and notify the entity of the merchant's unauthorized sharing of the e-mail address in instances where the sharing thereof may be against applicable rules or regulations.

In some embodiments, the processing server 108 may also be configured to monitor e-mail messages sent to the user 102 for violations. For instance, in a first embodiment, the user 102 may indicate to the processing server 108 (e.g., via the computing device 104) that the user 102 has unsubscribed to e-mails provided by the merchant 110. If the merchant 110 sends an unsolicited e-mail to the user 102 that is in violation of applicable rules or regulations based thereon, such as a regulation that prohibits unsolicited e-mails any later than 24 hours after unsubscription by a user 102, the processing server 108 may identify the merchant 110 and notify the applicable regulatory agency. In some instances, the merchant 110 may be directly identifiable in the e-mail message.

In other instances, the e-mail message may include information suitable for identification of the merchant 110, such as a uniform resource locator (URL) or hyperlink to a website where products may be offered for purchase that may be traced back to the merchant 110. In such an instance, the processing server 108 may communicate with a payment network 112 configured to process payment transactions, and may initiate a payment transaction via the URL or hyperlink in the e-mail message, which may be identified by the payment network 112, such as via the use of a previous identified transaction account, which may use data contained in a transaction message to identify the merchant 110. Example methods and systems for the identification of a merchant 110 associated with an unsolicited e-mail message can be found in U.S. patent application Ser. No. 14/071,775, entitled “Method and System for Automated Detection of Can-Spam Violations by Merchants and Acquirers,” by Justin Xavier Howe, filed on Nov. 5, 2013, which is herein incorporated by reference in its entirety.

In a second embodiment, the processing server 108 may identify unauthorized e-mail messages and/or the sharing associated thereof via the use of aliasing. In such an embodiment, the user 102 may, using the computing device 104, request an alias e-mail address from the processing server 108. The processing server 108 may generate and/or identify an alias e-mail address that the user 102 may then provide to a merchant 110, mailing entity 106, or other entity that may distribute e-mail messages to the user 102, such as during an e-commerce transaction. The processing server 108 may be configured to forward e-mail messages sent to the alias e-mail address to a generic (e.g., non-alias) e-mail address held by the user 102. When an e-mail message is sent to the alias e-mail address, the processing server 108 may identify the source of the e-mail message. If the source is not the entity for whom the alias e-mail address was identified and provided, then the processing server 108 may identify both that the source of the e-mail message is an unauthorized sender, and that the entity to whom the alias e-mail address was provided shared the e-mail address without proper authorization. In doing so, the processing server 108 may be able to easily identify unauthorized e-mail messages and the entities associated with their creation and distribution.

In some instances, the processing server 108 may be configured to generate alias e-mail addresses automatically for the user 102, for management of e-mail messages for the user 102 and identification of entities in violation of applicable rules and regulations. In such an instance, when the user 102 uses the computing device 104 to navigate to a webpage that includes an e-mail address field, the processing device 108 may automatically generate a unique alias e-mail address for population of the e-mail address field. In some cases, the field may be automatically populated by the computing device 104. In other cases, the user 102 may press a button or otherwise indicate that the field is to be populated with a unique alias e-mail address. In yet more cases, the user 102 may provide their generic e-mail address, and, when the form is submitted, the generic e-mail address may be switched out for the alias e-mail address, such that the processing server 108 may properly identify the generic e-mail address to which e-mail messages sent to the alias e-mail address are to be forwarded to. In such an instance, the user 102 may be provided the benefits of alias e-mail addresses without knowledge of the actual alias e-mail addresses and without having to provide any e-mail address other than their generic one.

In such embodiments, the computing device 104 may be in communication with the processing server 108 during the loading and/or submitting of web page data. In some instances, the computing device 104 and the processing server 108 may be a single device. For example, the functions of the processing server 108 discussed herein may be implemented in hardware and software of the computing device 104, such that the computing device 104 itself may generate and use alias e-mail addresses as discussed herein.

Accordingly, the processing server 108 may, via the methods and systems discussed herein, vastly improve the management of e-mail messages for users 102 and the identification of entities involved in the unauthorized distribution of e-mail messages and sharing of e-mail addresses. By managing a user's e-mail address sharing permissions, and by monitoring e-mail distribution lists for mailing entities 106, the processing server 108 may identify when e-mail addresses are shared without proper authorization, and may identify entities associated in the unauthorized activity, which existing systems and methods for managing e-mail addresses and messages are unable to do. In addition, the use of alias e-mail addresses may enable the processing server 108 to quickly and easily identify unsolicited and/or unauthorized e-mail messages with certainty that is unavailable to existing filtering systems and programs, as well as to identify when an e-mail address is shared without authorization and the entities involved thereof, information that is currently unobtainable using existing methods and systems.

### Processing Server

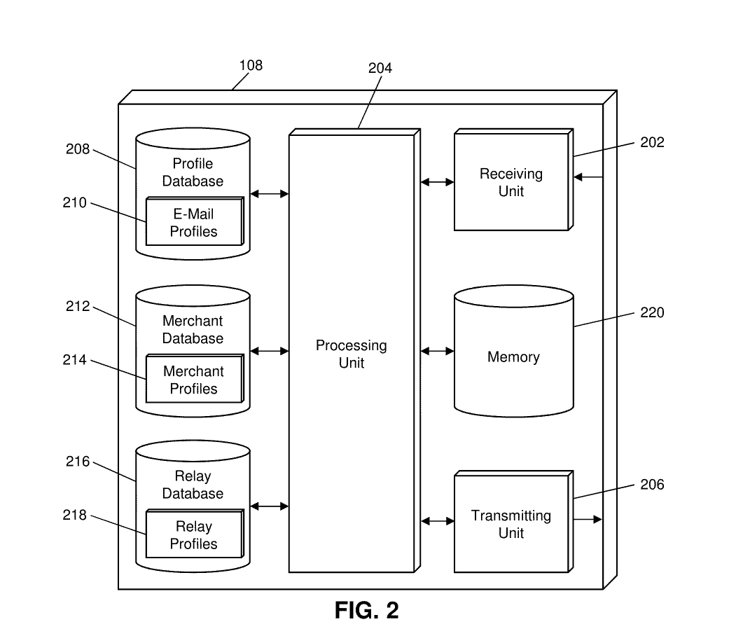

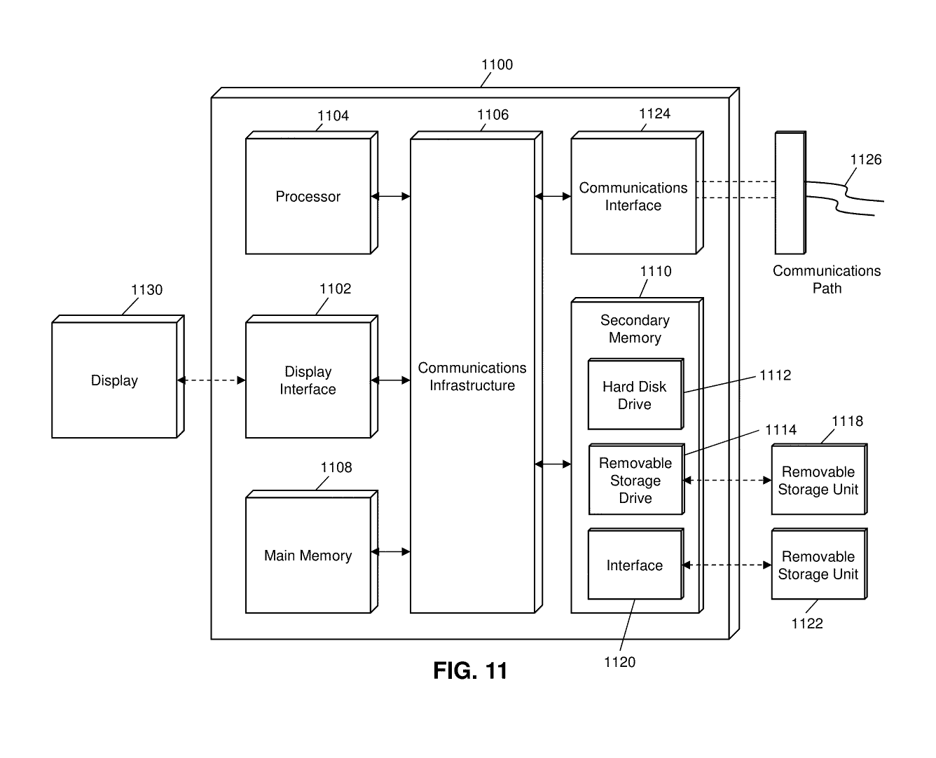

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 1100 illustrated in FIG. 11 and discussed in more detail below may be a suitable configuration of the processing server 108.

The processing server 108 may include a receiving unit 202. The receiving unit 202 may be configured to receive data over one or more networks via one or more network protocols. The receiving unit 202 may receive e-mail messages, such as from mailing entities 106, may receive permission and sharing data from computing devices 104, may receive alias requests from computing devices 104, may receive regulatory information from a suitable entity or via an one or more input devices, etc. Information received by the receiving unit 202 may be processed appropriately via a processing unit 204 included in the processing server 108. The processing unit 204 may be configured to perform the functions of the processing server 108 discussed herein, as will be apparent to persons having skill in the relevant art.

The processing server 108 may also include a transmitting unit 206. The transmitting unit 206 may be configured to transmit data over one or more networks via one or more network protocols. The transmitting unit 206 may transmit, for example, alias e-mail addresses to the computing device 104, mailing entities 106, merchants 110, etc., validated or unauthorized e-mail addresses to mailing entities 106, mailing entity 106 or merchant 110 information to regulatory agencies, forward e-mail messages to computing devices 104, etc. The transmitting unit 206 may also transmit data to one or more web pages or application programs, which may be executed by the computing device 104, for management of information, settings, e-mail addresses, and e-mail messages by the user 102.

The processing server 108 may also include a profile database 208. The profile database 208 may be configured to store a plurality of e-mail profiles 210. Each e-mail profile 210 may be configured to store data related to an e-mail address including at least the related e-mail address and one or more associated permissions. Each permission may be associated with at least one entity, such as a merchant 110, mailing entity 106, or other suitable entity, and may be associated with a restriction on sharing. The restriction on sharing may indicate a restriction (e.g., or lack thereof) on the authorization of the associated entity to distribute e-mail messages to the corresponding e-mail address or to share the corresponding e-mail address with other entities.

The processing unit 204 may be configured to identify e-mail messages that may be transmitted to an e-mail address included in an e-mail profile 210 that are in violation of a rule or regulation or that are otherwise unauthorized by an associated user 102, based on the data included therein. For instance, if an e-mail message is transmitted to the e-mail address of an e-mail profile 210 from an entity unauthorized to transmit messages to the e-mail address, or if e-mail messages sent to the e-mail address of the e-mail profile 210 originate from an entity that obtained the e-mail address from another entity in violation of the associated permissions, the processing unit 204 may identify the instance and may take appropriate action. Appropriate action may include filtering of the e-mail message(s), notification to the entity or an associated entity (e.g., the mailing entity 106 that distributes e-mail messages for the violative entity), and notification to a regulatory agency, such as one that has established rules and regulations for which the unauthorized sending or sharing may be in violation of.

The processing server 108 may also include a merchant database 212. The merchant database 212 may be configured to store a plurality of merchant profiles 214. Each merchant profile 214 may include data related to a merchant 110 and may include a merchant identifier. The merchant identifier may be a unique value associated with the merchant profile 214 and/or related merchant 110 used for the identification thereof, such as an identification number, transaction account number, tax identification number, username, etc. In some instances, the merchant profiles 214 stored in the merchant database 212 may be related to merchants 110 identified as presenting a high risk to financial institutions, such as due to the sending of unauthorized e-mail messages or the unauthorized sharing of e-mail addresses.

The processing unit 204 may be configured to identify merchants 110 involved in the unauthorized sending of e-mail messages or sharing of e-mail addresses, as discussed herein. In some embodiments, if the merchant 110 violates a rule or regulation as a result of the unauthorized activity, information associated with the merchant 110 may be stored in a merchant profile 214 of the merchant database 212. In some instances, the transmitting unit 206 may transmit a notification to entities associated with the merchant 110 indicating that the merchant 110 is a “high risk” merchant, such as due to risk that the merchant 110 may be fined, reprimanded, prohibited from acting, or otherwise negatively affected due to the violative activity. For example, the following entities may be notified via the transmitting unit 206 of the merchant's status and/or activity: a financial institution associated with the merchant 110, such as an acquiring bank; a mailing entity 106 that distributes e-mail messages for the merchant 110, entities that provide e-mail addresses to the merchant 110; payment networks 112 that process payment transactions for the merchant 110; or other associated entities.

The processing server 108 may further include a relay database 216. The relay database 216 may be configured to store a plurality of relay profiles 218. Each relay profile 218 may include data associated with an open relay including at least associated entity data. The processing unit 204 may be configured to identify e-mail messages that are sent via an open relay, if in violation of a rule or regulation, by identifying e-mail messages having originated from, been transmitted through, or otherwise having involved an entity indicated in a relay profile 218. For example, if a relay profile 218 includes information identifying a specific mailing entity 106, and the receiving unit 202 receives an e-mail message to be transmitted to a computing device 104 that is sent via the specific mailing entity 106, the processing unit 204 may identify the e-mail message as being in violation of a rule or regulation prohibiting the use of an open relay for the distribution of e-mail messages. In such an instance, the processing unit 204 may also identify a merchant 110 or other entity involved in the creation and/or distribution of the violative message, and may store associated data in the merchant database 212.

In some embodiments, e-mail profiles 210 stored in the e-mail database 208 may also include alias data. The alias data may include an alias e-mail address, associated with the e-mail address related to the respective e-mail profile 210, and an authorized entity associated with the alias e-mail address. The processing unit 204 may be configured to identify e-mail messages sent to the alias e-mail address and may forward the e-mail message to the related e-mail address if the e-mail message is proper (e.g., originated from the authorized entity), or may filter the e-mail message if improper (e.g., originated from an unauthorized entity). In the latter case, the processing unit 204 may identify the unauthorized entity and the authorized entity as both being in violation of a rule or regulation (e.g., for the unauthorized sending of the e-mail message and the unauthorized sharing of the e-mail address, respectively), which may include storing merchant profiles 214 in the merchant database 212 for each entity and/or the transmitting of a notification to a regulatory agency via the transmitting unit 206.

In some instances, the processing unit 204 may also be configured to identify and/or generate the alias e-mail addresses. Alias e-mail addresses may be associated with the related e-mail address, such as by including one or more characters included therein, may be unrelated to the associated e-mail address, or may be randomly generated or identified. For example, the processing server 108 may include a memory 220, which may store a list of unassigned e-mail addresses that may be used as an alias e-mail address. In another example, the memory 220 may include rules and/or algorithms used for the generation of alias e-mail addresses. Alias e-mail addresses may be stored in e-mail profiles 210 and distributed by the transmitting unit 206 to the appropriate entity (e.g., computing device 104, mailing entity 106, merchant 110, etc.) accordingly.

The memory 220 may be configured to store data suitable for performing the functions of the processing server 108 as discussed herein. For example, the memory 220 may store the unassigned e-mail addresses, may store rules and/or algorithms for generating alias e-mail addresses, filtering e-mail messages, forwarding e-mail messages, identifying merchants 110 or entities, validating e-mail distribution lists, etc., may store communication data for communicating with computing devices 104 and mailing entities 106, etc. Additional data stored in the memory 220 will be apparent to persons having skill in the relevant art.

It will be apparent to persons having skill in the relevant art that, in some embodiments, the processing server 108 may include additional components and/or that the components illustrated in FIG. 2 and discussed herein may be further configured to perform additional functions. For example, in instances where the computing device 104 may be configured to perform the functions of the processing server 108 as discussed herein, the components illustrated in FIG. 2 and discussed above may be further configured to perform the traditional functions of a computing device 104, such as by storing an operating system in the memory 220 and execution thereof by the processing unit 204.

### Process for Validating E-Mail Distribution Lists

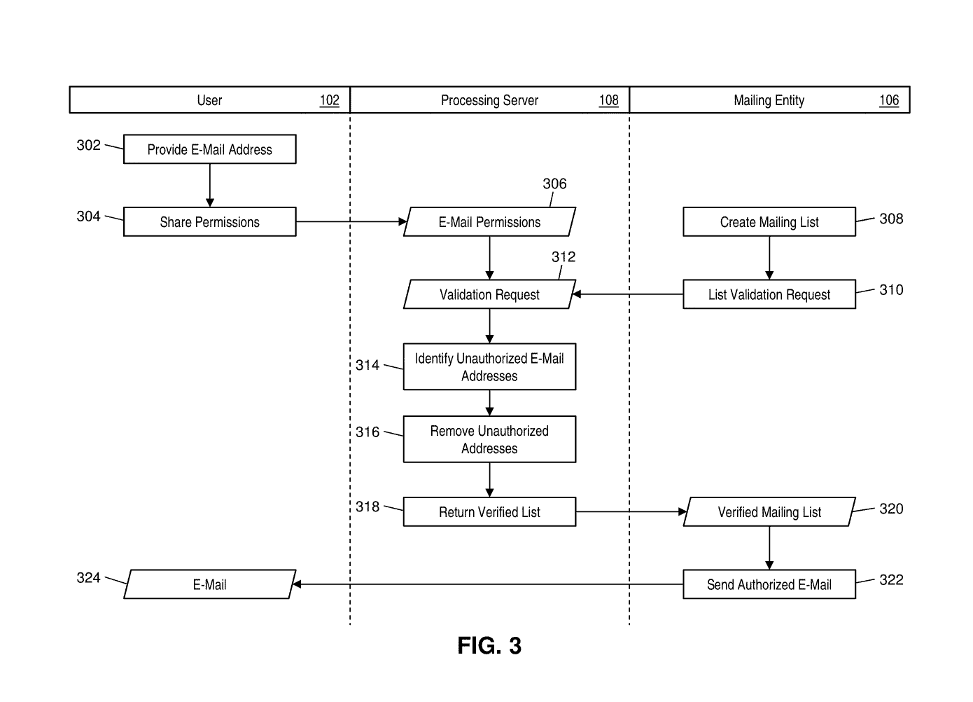

FIG. 3 illustrates a process for the validation of an e-mail distribution list based on user permissions in the system 100.

In step 302, the user 102 may provide their e-mail address to an entity, such as a specific merchant 110. For example, the user 102 may register an account with the merchant 110 using their e-mail address. During the registration, the user 102 may indicate their permissions regarding the sharing and/or use of the e-mail address to the merchant 110. In step 304, the user 102 may share (e.g., via the computing device 104) the entity and the user's indicated permissions regarding their e-mail address, to the processing server 108. In step 306, the receiving unit 202 of the processing server 108 may receive the e-mail permissions for the e-mail and their associated entities. Steps 302 through 306 may be performed multiple times, such as for multiple sharing instances by the user 102 and/or for multiple users.

In step 308, the mailing entity 106 may create a mailing list. The mailing list may include a plurality of e-mail addresses to which e-mail messages are to be distributed. The mailing list may also be appended with data indicating the source of each e-mail address on the mailing list. In step 310, the mailing entity 106 may transmit a list validation request to the processing server 108. In step 312, the receiving unit 202 of the processing server 108 may receive the validation request. The validation request may include the mailing list and the appended source data.

In step 314, the processing unit 204 of the processing server 108 may identify unauthorized e-mail addresses included in the mailing list. Unauthorized e-mail addresses may be e-mail addresses whose source data indicates a violation of permissions associated with the e-mail address, as received by the processing server 108 in step 306. For example, if the e-mail permissions provided by a user 102 indicate that a specific merchant 110 is unauthorized to share their e-mail address, and the mailing list includes the e-mail address and source data indicating that it was shared by the specific merchant 110, the e-mail address may be considered unauthorized for the mailing list. In step 316, the processing unit 204 may remove the unauthorized e-mail addresses from the mailing list.

In step 318, the transmitting unit 206 of the processing server 108 may transmit the mailing list, with the unauthorized e-mail addresses removed, back to the mailing entity 106. In some instances, the transmitting unit 206 may transmit just the unauthorized e-mail addresses and indications thereof as the e-mail addresses being unauthorized, or may transmit the mailing list back in its entirety with the unauthorized e-mail addresses being indicated. In some embodiments, the verified list may indicate verifications by the processing server 108 for each e-mail address that complies with permissions provided by the associated user 102. In instances where permission data is unavailable for an e-mail address, the verified list may include no indication as to status, or may include an indication that such information is unavailable.

In step 320, the mailing entity 106 may receive the verified mailing list. In step 322, the mailing entity 106 may distribute e-mail messages to e-mail addresses whose sharing or distribution of messages thereto is authorized. In step 324, the users 102 whose permissions indicate that their e-mail addresses are used properly may receive the properly distributed e-mail messages.

### Process for Identifying Violative Merchants

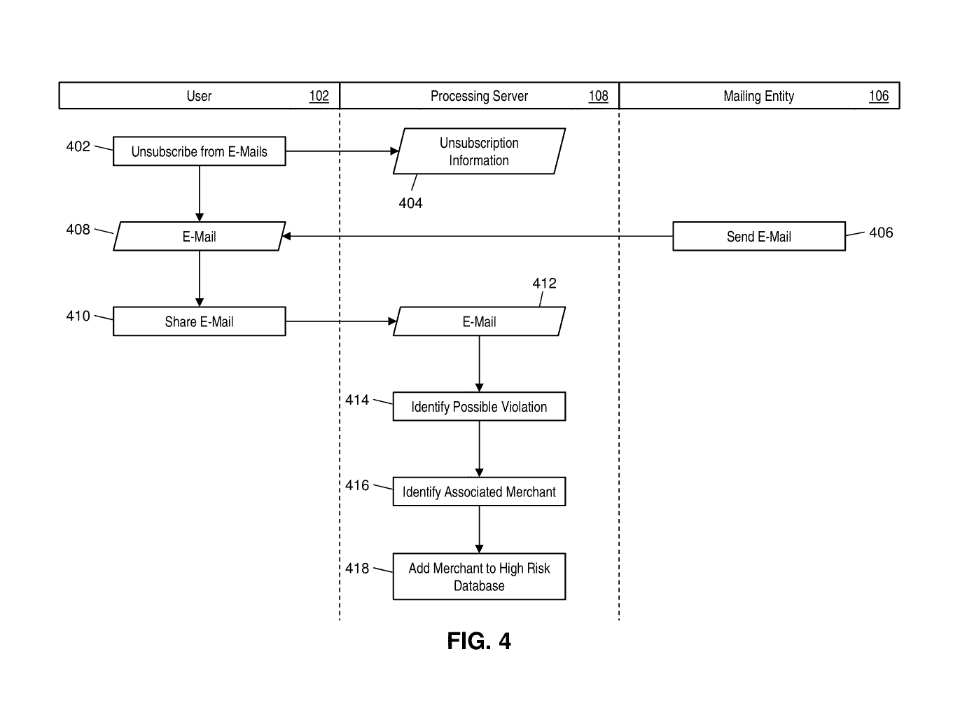

FIG. 4 illustrates a process for the identification of a merchant associated with the distribution of an e-mail message in violation of a rule or regulation in the system 100.

In step 402, the user 102 may unsubscribe from e-mails for a particular merchant 110 using methods and systems that will be apparent to persons having skill in the relevant art. In step 404, the receiving unit 202 of the processing server 108 will receive data associated with the unsubscription. The data may include at least the entity with whom the user 102 unsubscribed and the associated e-mail address. In some embodiments, the user 102 may submit (e.g., via the computing device 104) the information to the processing server 108 directly following unsubscribing. In other embodiments, the user 102 may provide the information to the processing server 108, which may be configured to unsubscribe the e-mail address with the entity on behalf of the user 102. The processing unit 204 of the processing server 108 may be configured to store data associated with the unsubscription in a corresponding e-mail profile 210.

In step 406, the mailing entity 106 may send an e-mail message to the user 102, which may receive (e.g., via the computing device 104) the e-mail message in step 408. In step 410, the user 102 may share the e-mail with the processing server 108. In step 412, the receiving unit 202 of the processing server 108 may receive the e-mail. In some embodiments, the processing server 108 may receive the e-mail directly from the mailing entity 106, such as in instances where the processing server 108 may manage e-mail for the user 102 directly.

In step 414, the processing unit 204 may identify possible violations in the transmitting of the e-mail message to the user 102. In some embodiments, the processing unit 204 may identify if the e-mail message was sent in violation of a rule or regulation regarding unsubscription to e-mail messages. For example, if the e-mail message originates from the entity to which the user 102 unsubscribed in step 402 and is unsolicited, then the processing unit 204 may identify the message as having been sent in violation by the entity. In some instances, the processing unit 204 may identify if the e-mail message was sent via an open relay in violation of an applicable rule or regulation, such as by identifying the mailing entity 106 or another entity involved in the distribution of the e-mail message as being included in a relay profile 218 of the relay database 216.

In step 416, the processing unit 204 may identify a merchant 110 associated with the violative e-mail message. The merchant 110 may be identified using methods and systems that will be apparent to persons having skill in the relevant art, such as via header information, information included in the message data of the e-mail message, via the conducting of a payment transaction using a URL included in the message data of the e-mail, etc. In step 418, the associated merchant 110 may be stored in a merchant profile 214 in the merchant database 212, indicating the merchant 110 to be a high risk merchant as a result of their violative activity. In some embodiments, the transmitting unit 206 may also transmit a notification to entities associated with the merchant 110, such as associated financial institutions.

### Process for Identifying and Using Alias E-Mail Addresses

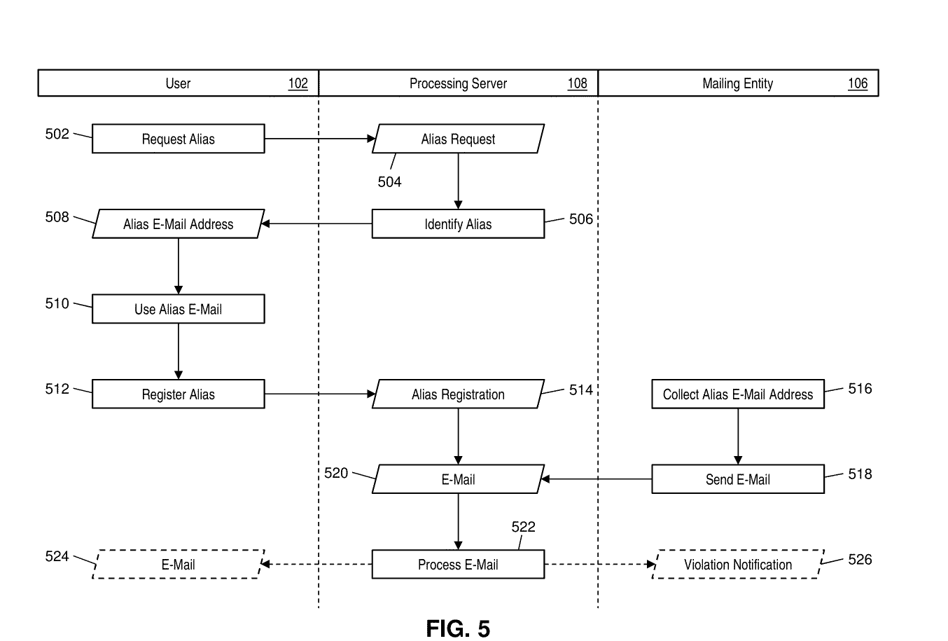

FIG. 5 illustrates a process for the identification and of use of alias e-mail addresses in the system 100 for managing of e-mail messages and identification of unauthorized entities by the processing server 108.

In step 502, the user 102 may request an alias, using the computing device 104, from the processing server 108. In some instances the computing device 104 may submit the alias request to the processing server 108 automatically, such as upon loading a web page that includes a form having an e-mail address field. In step 504, the receiving unit 202 of the processing server 108 may receive the alias request. The alias request may include at least the generic (e.g., non-alias) e-mail address to which messages transmitted to the alias e-mail address are to be forwarded. In step 506, the processing unit 204 of the processing server 108 may identify an alias e-mail address.

In step 508, the transmitting unit 206 of the processing server 108 may transmit the alias e-mail address for receipt by the user 102 (e.g., via the computing device 104). In step 510, the user 102 may use the alias e-mail address. Use of the alias e-mail address may include the providing of the alias e-mail address to a merchant 110 or other entity, such as during the registration of an account, while conducting of a payment transaction, subscribing to a newsletter, etc. In some embodiments, the computing device 104 may use the alias e-mail address automatically, such as by entering it and submitting it in a web page that prompted the computing device 104 to request the alias e-mail address automatically. In some instances, the computing device 104 may swap a generic e-mail address entered by the user 102 automatically to the alias e-mail address.

In step 512, the user 102 may register use of the alias e-mail address with the processing server 108. In step 514, the receiving unit 202 of the processing server 108 may receive the alias registration. The alias registration may include at least the generic (e.g., forwarding) e-mail address, the alias e-mail address, and the entity to which the alias e-mail address was provided. In some instances, alias registration data may also include permission data for use of the alias e-mail address by the entity. In some embodiments, the alias registration data may be included in the alias request provided to the processing server 108 in step 504. In such an embodiment, steps 512 and 514 may not be performed.

In step 516, the mailing entity 106 may collect the alias e-mail address. In some instances, the mailing entity 106 may by the authorized entity identified by the user 102 during the generation and/or obtaining of the alias e-mail address. In other instances, the mailing entity 106 may be distributing e-mail messages on behalf of the authorized entity. In yet other instances, the mailing entity 106 may obtain the alias e-mail address via unauthorized sharing of the e-mail address by the authorized entity. In step 518, the mailing entity 106 may transmit an e-mail message to the alias e-mail address.

In step 520, the receiving unit 202 of the processing server 108 may receive the e-mail message sent to the alias e-mail address. In step 522, the processing unit 204 of the processing server 108 may process the e-mail message based on if the distribution of the e-mail message complies with the permissions provided by the user 102. For example, if the e-mail message originated from the authorized entity, then, in step 524, the transmitting unit 206 may forward the e-mail message to the forwarding e-mail address to be received by the user 102 (e.g., via the computing device 104). In another example, if the e-mail message is sent by an unauthorized entity, then rather than forward the e-mail message to the forwarding e-mail address to be received by the user 102, the transmitting unit 206 may transmit, in step 526, a notification to the mailing entity 106 that the alias e-mail address was obtained in violation of user permissions, and, if applicable, further in violation of rules or regulations. In some instances, the violation notification may be transmitted to an associated regulatory agency.

### Process for Automatic Generation of Alias E-Mail Addresses

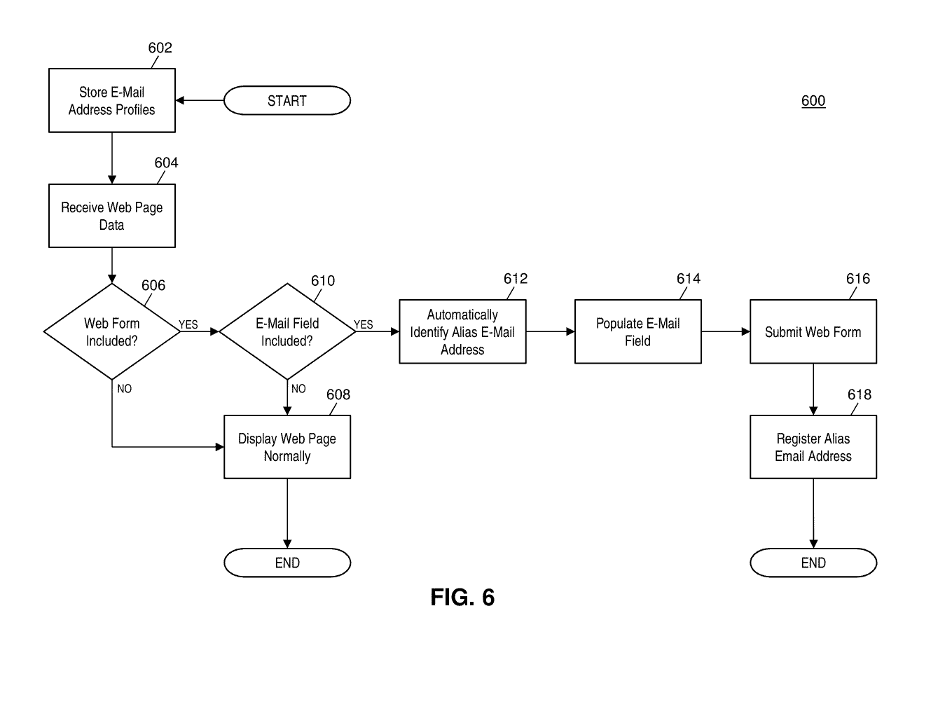

FIG. 6 illustrates a process 600 for the automatic generation and submission of an alias e-mail address for use in managing e-mail messages. As discussed herein, the process 600 discusses use of the computing device 104 and the processing server 108 as a single device. It will be apparent to persons having skill in the relevant art that the computing device 104 and processing server 108 are provided as a single computing device for illustrative purposes only, and that different configurations of the system 100 for carrying out the process 600 illustrated in FIG. 6 and discussed herein may be used.

In step 602, the processing unit 204 may store e-mail address profiles 210 in the profile database 208. The e-mail address profiles 210 may include at least one e-mail address profile 210 related to an e-mail address being used by a specific user 102 of a specific computing device 104. In step 604, the receiving unit 202 may receive web page data for a web page visited by the specific user 102. In step 606, the processing unit 204 may determine if a form is included in the web page data. If there is no form in the web page data, then, in step 608, the processing unit 204 may display the web page to the user 102 via a display device as normal.

If the web page data does indicate that the web page includes a web form, then, in step 610, the processing unit 204 may determine if an e-mail field is included in the web form. An e-mail field may be identified via text displayed on the web page, form data encoded in the web page data, or other suitable method that will be apparent to persons having skill in the relevant art. If the web form does not include an e-mail field, then the process may proceed to step 608 where the web page is displayed normally to the user 102.

If the web page does include a web form that includes an e-mail field, then, in step 612, the processing unit 204 may automatically identify an alias e-mail address. In instances where the computing device 104 and processing server 108 may be separate devices, the computing device 104 may automatically request an alias e-mail address from the processing server 108, which may identify and return an alias e-mail address to the computing device 104. In step 614, the e-mail field may be populated. In some embodiments, the e-mail field may be populated by the alias e-mail address. In other embodiments, the e-mail field may be populated by the forwarding e-mail address in the display to the user 102, but may be exchanged for the alias e-mail address by the processing unit 204 upon submission of the form.

In step 616, the web form may be submitted via instructions received from the user 102. Submission of the web form may include transmitting the alias e-mail address to an entity associated with the form. In step 618, the processing unit 204 may register the alias e-mail address in the e-mail profile 210 corresponding to the forward e-mail address, and may indicate a merchant 110 or other entity associated with the alias e-mail address based on data included in the web page. For example, if the web page or URL is associated with a merchant 110, the alias e-mail address may be associated with the merchant 110 in the respective e-mail profile 210. In embodiments where the computing device 104 and processing server 108 are separate devices, step 618 may include transmitting entity information to the processing server 108 for registration of the alias e-mail address.

In some embodiments, the process 600 may also include the generation of aliases for additional data fields, such as name, address, etc. In some instances, the aliases may be fake or otherwise inaccurate information that may be provided to the merchant 110 or other entity, such that the identity of the user 102 may be protected. In some cases, the alias information may be presented in instances where real information may not be necessary. For example, if the user 102 is signing up for a newsletter, an alias name and/or address may be provided, but if the user 102 is purchasing a product, the user's actual address, but an alias name, may be provided for proper shipping. In some embodiments, the user 102 may indicate for which fields an alias should be provided. In other embodiments, the processing server 108 and/or computing device 104 may identify alias fields, such as based on form data, website data, or other suitable values.

### Exemplary Method for Moderating an E-Mail Distribution List

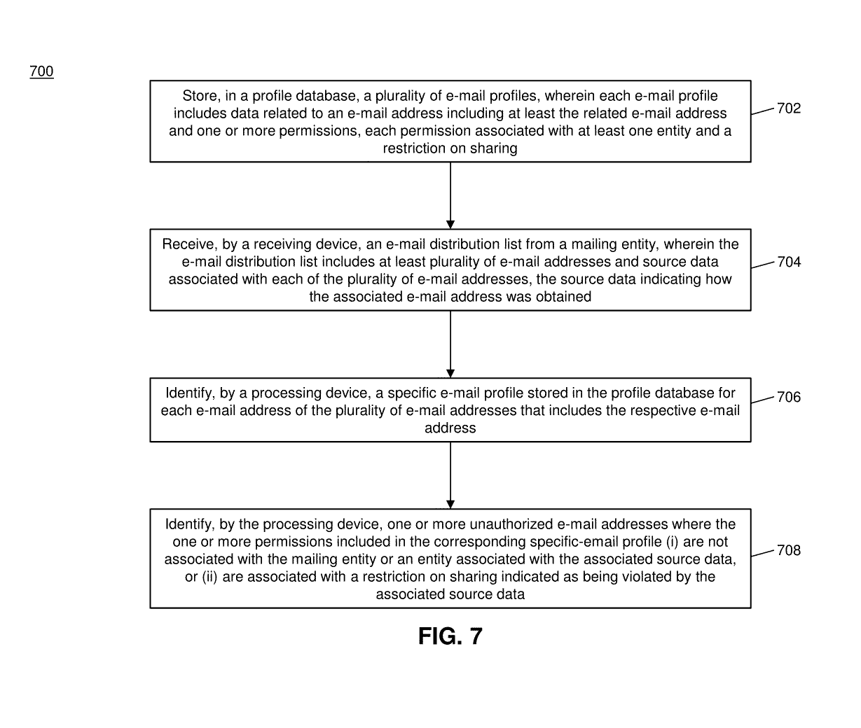

FIG. 7 illustrates a method 700 for moderating an e-mail distribution list based on user permissions.

In step 702, a plurality of e-mail profiles (e.g., e-mail profiles 210) may be stored in a profile database (e.g., profiles database 208), wherein each e-mail profile 210 includes data related to an e-mail address including at least the related e-mail address and one or more permissions, each permission associated with at least one entity and a restriction on sharing. In step 704, an e-mail distribution list may be received from a mailing entity (e.g., the mailing entity 106) by a receiving device (e.g., the receiving unit 202), wherein the e-mail distribution list includes at least a plurality of e-mail addresses and source data associated with each of the plurality of e-mail addresses, the source data indicating how the associated e-mail address was obtained.

In step 706, a specific e-mail profile 210 stored in the profile database 208 may be identified by a processing device (e.g., the processing unit 204) for each e-mail address of the plurality of e-mail addresses that includes the respective e-mail address. In step 708, one or more unauthorized e-mail addresses may be identified by the processing device 204 where the one or more permissions included in the corresponding specific e-mail profile 210 (i) are not associated with the mailing entity 106 or an entity associated with the associated source data, or (ii) are associated with a restriction on sharing indicated as being violated by the associated source data.

In one embodiment, the method 700 may further include transmitting, by a transmitting device (e.g., the transmitting unit 206), at least the identified one or more unauthorized e-mail addresses to the mailing entity 106. In some embodiments, the method 700 may also include: updating, by the processing device 204, the e-mail distribution list by removing each of the identified one or more unauthorized e-mail addresses from the plurality of e-mail addresses; and transmitting, by the transmitting device 206, at least the updated e-mail distribution list to the mailing entity 106. In one embodiment, the method 700 may further include transmitting, by the transmitting device 206, a certification to the mailing entity 106, wherein the certification indicates that each e-mail address of the plurality of e-mail addresses not included in the identified one or more unauthorized e-mail addresses was obtained with permission of a user (e.g., the user 102) associated with the respective e-mail address.

In some embodiments, the method 700 also include: storing, in a merchant database (e.g., the merchant database 212), a plurality of merchant profiles (e.g., merchant profiles 214), wherein each merchant profile 214 includes data related to a high risk merchant (e.g., the merchant 110) including at least a merchant identifier associated with the related high risk merchant 110; receiving, by the receiving device 202, an indication of an e-mail transmitted to at least one of the identified one or more unauthorized e-mail addresses from the mailing entity 106; and generating, by the processing device 204, a new merchant profile 214 for storage in the merchant database 212, wherein the new merchant profile 214 includes a specific merchant identifier associated with the mailing entity 106. In a further embodiment, receiving the indication of the e-mail transmitted to the at least one of the identified one or more unauthorized e-mail addresses from the mailing entity 106 indicates violation of a rule or regulation. In an even further embodiment, each high risk merchant 110 related to a merchant profile 214 of the plurality of merchant profiles is in violation of the rule or regulation.

### Exemplary Method for Identifying High Risk Merchants

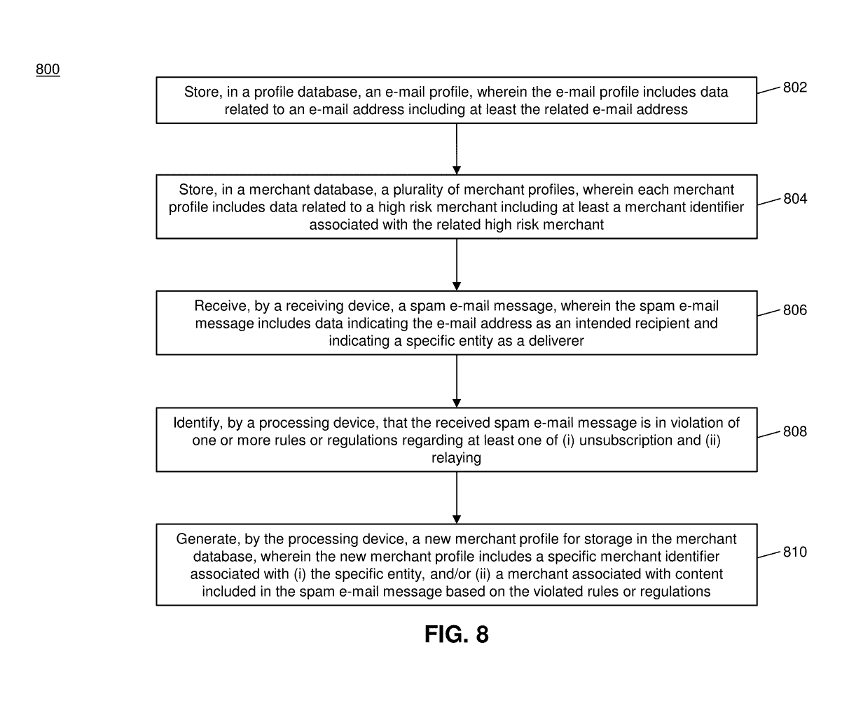

FIG. 8 illustrates a method 800 for the identification of merchants as high risk merchants due to violative activity in the sharing of e-mail addresses and distribution of e-mail messages.

In step 802, an e-mail profile (e.g., e-mail profile 210) may be stored in a profile database (e.g., the profile database 208), wherein the e-mail profile 210 includes data related to an e-mail address including at least the related e-mail address. In step 804, a plurality of merchant profiles (e.g., merchant profiles 214) may be stored in a merchant database (e.g., the merchant database 212) wherein each merchant profile 214 includes data related to a high risk merchant (e.g., the merchant 110) including at least a merchant identifier associated with the related high risk merchant 110.

In step 806, a spam e-mail message may be received by a receiving device (e.g., the receiving unit 202) wherein the spam e-mail message includes data indicating the e-mail address as an intended recipient and indicating a specific entity as a deliverer. In step 808, the received spam e-mail message may be identified by a processing device (e.g., the processing unit 204) as being in violation of one or more rules or regulations regarding at least one of (i) unsubscription and (ii) relaying. In one embodiment, the e-mail profile 210 may further include one or more unsubscriptions with each unsubscription including an unsubscribed entity and an unsubscription time and/or date, and the received spam e-mail message may be identified as in violation of one or more rules or regulations regarding unsubscription if the one or more unsubscriptions (i) includes an unsubscribed entity corresponding to the specific entity, and (ii) an unsubscription time and/or date at least a predetermined period of time prior to a receipt time and/or date included in the data included in the received spam e-mail message.

In step 810, a new merchant profile 214 may be generated for storage in the merchant database 212 by the processing device 204, wherein the new merchant profile 214 includes a specific merchant identifier associated with (i) the specific entity, and/or (ii) a merchant 110 associated with content included in the spam e-mail message based on the violated rules or regulations. In one embodiment, the method 800 may further include storing, in a relay database (e.g., the relay database 216), a plurality of relay profiles (e.g., relay profiles 218), wherein each relay profile 218 includes data associated with an open relay including at least associated entity data, wherein the received spam e-mail message is identified as in violation of one or more rules or regulations regarding relaying if the associated entity data included in at least one of the plurality of relay profiles 218 corresponds to the specific entity indicated in the data included in the received spam e-mail message.

### Exemplary Method for Identifying Violative E-Mails Using Aliasing

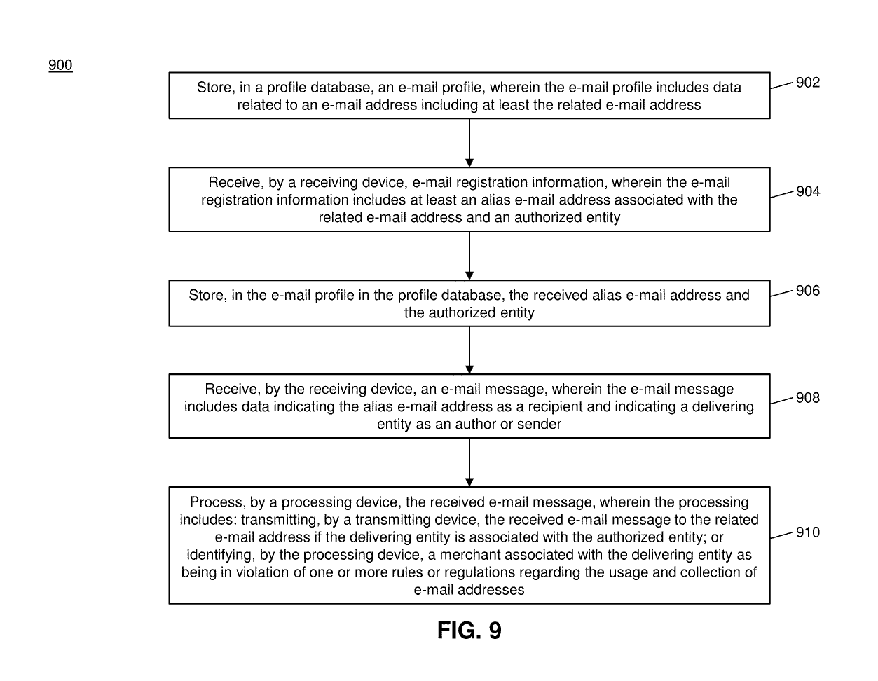

FIG. 9 illustrates a method 900 for the identification of e-mails in violation of sharing and/or usage permissions via the use of aliasing.

In step 902, an e-mail profile (e.g., e-mail profile 210) may be stored in a profile database (e.g., the profile database 208), wherein the e-mail profile 210 includes data related to an e-mail address including at least the related e-mail address. In step 904, e-mail registration information may be received by a receiving device (e.g., the receiving unit 202), wherein the e-mail registration information includes at least an alias e-mail address associated with the related e-mail address and an authorized entity.

In step 906, the received alias e-mail address and the authorized entity may be stored in the e-mail profile 210 in the profile database 208. In step 908, an e-mail message may be received by the receiving device 202, wherein the e-mail message includes data indicating the alias e-mail address as a recipient and indicating a delivering entity as an author or sender. In step 910, the received e-mail message may be processed by a processing device (e.g., the processing unit 204), wherein the processing includes: transmitting, by a transmitting device (e.g., the transmitting unit 206), the received e-mail message to the related e-mail address if the delivering entity is associated with the authorized entity; or identifying, by the processing device 204, a merchant (e.g., the merchant 110) associated with the delivering entity as being in violation of one or more rules or regulations regarding the usage and collection of e-mail addresses.

In one embodiment, the method 900 may further include storing, in a merchant database (e.g., the merchant database 212), a plurality of merchant profiles (e.g., merchant profiles 214), wherein each merchant profile 214 includes data related to a high risk merchant including at least a merchant identifier associated with the related high risk merchant, wherein identifying the merchant 110 associated with the delivering entity as being in violation of the one or more rules or regulations includes generating, by the processing device 204, a new merchant profile 214 for storage in the merchant database 212, wherein the new merchant profile 214 includes a specific merchant identifier associated with the merchant 110 associated with the delivering entity.

In some embodiments, the method 900 may also include: receiving, by the receiving device 202, an alias request, wherein the alias request includes at least the related e-mail address; identifying, by the processing device 204, the alias e-mail address associated with the related e-mail address; and transmitting, by the transmitting device 206, the identified alias e-mail address. In a further embodiment, the e-mail registration information may be received from the processing device 204 subsequent to identifying the alias e-mail address. In another further embodiment, identifying the alias e-mail address associated with the related e-mail address may include generating, by the processing device 204, the alias e-mail address using one or more address generation rules or algorithms. In an even further embodiment, the generated alias e-mail address may be based on the related e-mail address.

In another further embodiment, the method 900 may even further include storing, in an e-mail database (e.g., the memory 220), a plurality of unassigned e-mail addresses, wherein identifying the alias e-mail address associated with the related e-mail address includes identifying, by the processing device 204, an unassigned e-mail address in the e-mail database. In an even further embodiment, the method 900 may yet further include removing, from the e-mail database, the identified unassigned e-mail address.

### Exemplary Method for Automatic Submission of an Alias E-Mail Address

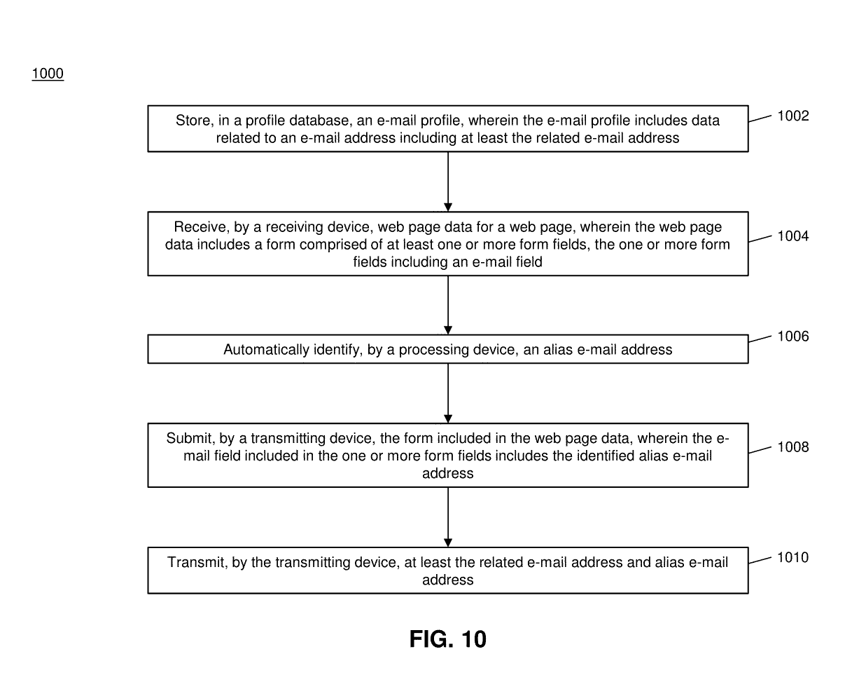

FIG. 10 illustrates a method 1000 for the automatic submission of an alias e-mail address in a webpage for moderation and filtering of e-mail messages and e-mail address sharing.

In step 1002, an e-mail profile (e.g., an e-mail profile 210) may be stored in a profile database (e.g., the profile database 208), wherein the e-mail profile 210 includes data related to an e-mail address including at least the related e-mail address. In step 1004, web page data for a web page may be received by a receiving device (e.g., the receiving unit 202), wherein the web page data includes a form comprised of at least one or more form fields, the one or more form fields including an e-mail field.

In step 1006, a processing device (e.g., the processing unit 204) may automatically identify an alias e-mail address. In some embodiments, the identified alias e-mail address may be based on the related e-mail address. In one embodiment, identifying the alias e-mail address may include transmitting an alias request and receiving, by the receiving device 202, the alias e-mail address. In one embodiment, identifying the alias e-mail address may include generating, by the processing device 204, the alias e-mail address using one or more address generation rules or algorithms.

In step 1008, the form included in the web page data may be submitted by a transmitting device (e.g., the transmitting unit 206), wherein the e-mail field included in the one or more form fields includes the identified alias e-mail address. In some embodiments, the identified alias e-mail address may be included in the e-mail field automatically by the processing device 204. In step 1010, at least the related e-mail address and alias e-mail address may be transmitted by the transmitting device 206.

In one embodiment, the method 1000 may further include storing, in an e-mail database (e.g., the memory 220) a plurality of unassigned e-mail addresses, wherein identifying the alias e-mail address associated with the related e-mail address includes identifying, by the processing device 204, an unassigned e-mail address in the e-mail database. In a further embodiment, the method 1000 may even further include removing, from the e-mail database, the identified unassigned e-mail address.

### Computer System Architecture

FIG. 11 illustrates a computer system 1100 in which embodiments of the present disclosure, or portions thereof, may be implemented as computer-readable code. For example, the processing server 118 of FIG. 1 may be implemented in the computer system 1100 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-10.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1118, a removable storage unit 1122, and a hard disk installed in hard disk drive 1112.

Various embodiments of the present disclosure are described in terms of this example computer system 1100. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1104 may be a special purpose or a general purpose processor device. The processor device 1104 may be connected to a communications infrastructure 1106, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1100 may also include a main memory 1108 (e.g., random access memory, read-only memory, etc.), and may also include a secondary memory 1110. The secondary memory 1110 may include the hard disk drive 1112 and a removable storage drive 1114, such as a floppy disk drive, a magnetic tape drive, an optical disk drive, a flash memory, etc.

The removable storage drive 1114 may read from and/or write to the removable storage unit 1118 in a well-known manner. The removable storage unit 1118 may include a removable storage media that may be read by and written to by the removable storage drive 1114. For example, if the removable storage drive 1114 is a floppy disk drive or universal serial bus port, the removable storage unit 1118 may be a floppy disk or portable flash drive, respectively. In one embodiment, the removable storage unit 1118 may be non-transitory computer readable recording media.

In some embodiments, the secondary memory 1110 may include alternative means for allowing computer programs or other instructions to be loaded into the computer system 1100, for example, the removable storage unit 1122 and an interface 1120. Examples of such means may include a program cartridge and cartridge interface (e.g., as found in video game systems), a removable memory chip (e.g., EEPROM, PROM, etc.) and associated socket, and other removable storage units 1122 and interfaces 1120 as will be apparent to persons having skill in the relevant art.

Data stored in the computer system 1100 (e.g., in the main memory 1108 and/or the secondary memory 1110) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1100 may also include a communications interface 1124. The communications interface 1124 may be configured to allow software and data to be transferred between the computer system 1100 and external devices. Exemplary communications interfaces 1124 may include a modem, a network interface (e.g., an Ethernet card), a communications port, a PCMCIA slot and card, etc. Software and data transferred via the communications interface 1124 may be in the form of signals, which may be electronic, electromagnetic, optical, or other signals as will be apparent to persons having skill in the relevant art. The signals may travel via a communications path 1126, which may be configured to carry the signals and may be implemented using wire, cable, fiber optics, a phone line, a cellular phone link, a radio frequency link, etc.

The computer system 1100 may further include a display interface 1102. The display interface 1102 may be configured to allow data to be transferred between the computer system 1100 and external display 1130. Exemplary display interfaces 1102 may include high-definition multimedia interface (HDMI), digital visual interface (DVI), video graphics array (VGA), etc. The display 1130 may be any suitable type of display for displaying data transmitted via the display interface 1102 of the computer system 1100, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 1108 and secondary memory 1110, which may be memory semiconductors (e.g., DRAMs, etc.). These computer program products may be means for providing software to the computer system 1100. Computer programs (e.g., computer control logic) may be stored in the main memory 1108 and/or the secondary memory 1110. Computer programs may also be received via the communications interface 1124. Such computer programs, when executed, may enable computer system 1100 to implement the present methods as discussed herein. In particular, the computer programs, when executed, may enable processor device 1104 to implement the methods illustrated by FIGS. 3-10, as discussed herein. Accordingly, such computer programs may represent controllers of the computer system 1100. Where the present disclosure is implemented using software, the software may be stored in a computer program product and loaded into the computer system 1100 using the removable storage drive 1114, interface 1120, and hard disk drive 1112, or communications interface 1124.

Techniques consistent with the present disclosure provide, among other features, systems and methods for moderating e-mail distribution lists, identifying high risk merchants, identifying violative e-mails using aliasing, and automatically submitting alias e-mail addresses. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying violative e-mails using aliasing, comprising:
storing, in a profile database, an e-mail profile, wherein the e-mail profile includes data related to an e-mail address including at least the related e-mail address;
receiving, by a receiving device, e-mail registration information, wherein the e-mail registration information includes at least an alias e-mail address associated with the related e-mail address and an authorized entity;
storing, in the e-mail profile in the profile database, the received alias e-mail address and the authorized entity;
receiving, by the receiving device, an e-mail message, wherein the e-mail message includes data indicating the alias e-mail address as a recipient and indicating a delivering entity as an author or sender; and
processing, by a processing device, the received e-mail message, wherein the processing includes
transmitting, by a transmitting device, the received e-mail message to the related e-mail address if the delivering entity is associated with the authorized entity, or
identifying, by the processing device, a merchant associated with the delivering entity as being in violation of one or more rules or regulations regarding the usage and collection of e-mail addresses.

2. The method of claim 1, further comprising:
storing, in a merchant database, a plurality of merchant profiles, wherein each merchant profile includes data related to a high risk merchant including at least a merchant identifier associated with the related high risk merchant, wherein
identifying the merchant associated with the delivering entity as being in violation of the one or more rules or regulations includes
generating, by the processing device, a new merchant profile for storage in the merchant database, wherein the new merchant profile includes a specific merchant identifier associated with the merchant associated with the delivering entity.

3. The method of claim 1, further comprising:
receiving, by the receiving device, an alias request, wherein the alias request includes at least the related e-mail address;
identifying, by the processing device, the alias e-mail address associated with the related e-mail address; and
transmitting, by the transmitting device, the identified alias e-mail address.

4. The method of claim 3, wherein the e-mail registration information is received from the processing device subsequent to identifying the alias e-mail address.

5. The method of claim 3, further comprising:
storing, in an e-mail database, a plurality of unassigned e-mail addresses, wherein
identifying the alias e-mail address associated with the related e-mail address includes identifying, by the processing device, an unassigned e-mail address in the e-mail database.

6. The method of claim 5, further comprising:
removing, from the e-mail database, the identified unassigned e-mail address.

7. The method of claim 3, wherein identifying the alias e-mail address associated with the related e-mail address includes generating, by the processing device, the alias e-mail address using one or more address generation rules or algorithms.

8. The method of claim 7, wherein the generated alias e-mail address is based on the related e-mail address.

9. A method for automatic submission of an alias e-mail address, comprising:
storing, in a profile database, an e-mail profile, wherein the e-mail profile includes data related to an e-mail address including at least the related e-mail address;
receiving, by a receiving device, web page data for a web page, wherein the web page data includes a form comprised of at least one or more form fields, the one or more form fields including an e-mail field;
automatically identifying, by a processing device, an alias e-mail address;
submitting, by a transmitting device, the form included in the web page data, wherein the e-mail field included in the one or more form fields includes the identified alias e-mail address; and
transmitting, by the transmitting device, at least the related e-mail address and alias e-mail address.

10. The method of claim 9, wherein the identified alias e-mail address is included in the e-mail field automatically by the processing device.

11. The method of claim 9, wherein the alias e-mail address is based on the related e-mail address.

12. The method of claim 9, wherein identifying the alias e-mail address includes
transmitting, by the transmitting device, an alias request, and
receiving, by the receiving device, the alias e-mail address.

13. The method of claim 9, further comprising:
storing, in an e-mail database, a plurality of unassigned e-mail addresses, wherein
identifying the alias e-mail address associated with the related e-mail address includes identifying, by the processing device, an unassigned e-mail address in the e-mail database.

14. The method of claim 13, further comprising:
removing, from the e-mail database, the identified unassigned e-mail address.

15. The method of claim 9, wherein identifying the alias e-mail address includes generating, by the processing device, the alias e-mail address using one or more address generation rules or algorithms.

16. A system for identifying violative e-mails using aliasing, comprising:
a transmitting device;
a profile database configured to store an e-mail profile, wherein the e-mail profile includes data related to an e-mail address including at least the related e-mail address;
a receiving device configured to receive e-mail registration information, wherein the e-mail registration information includes at least an alias e-mail address associated with the related e-mail address and an authorized entity; and
a processing device configured to store, in the e-mail profile in the profile database, the received alias e-mail address and the authorized entity, wherein
the receiving device is further configured to receive an e-mail message, wherein the e-mail message includes data indicating the alias e-mail address as a recipient and indicating a delivering entity as an author or sender, and
the processing device is further configured to process the received e-mail message, wherein the processing includes
transmitting, by the transmitting device, the received e-mail message to the related e-mail address if the delivering entity is associated with the authorized entity, or
identifying, by the processing device, a merchant associated with the delivering entity as being in violation of one or more rules or regulations regarding the usage and collection of e-mail addresses.

17. The system of claim 16, further comprising:
a merchant database configured to store a plurality of merchant profiles, wherein each merchant profile includes data related to a high risk merchant including at least a merchant identifier associated with the related high risk merchant, wherein
identifying the merchant associated with the delivering entity as being in violation of the one or more rules or regulations includes generating, by the processing device, a new merchant profile for storage in the merchant database, wherein the new merchant profile includes a specific merchant identifier associated with the merchant associated with the delivering entity.

18. The system of claim 16, wherein
the receiving device is further configured to receive an alias request, wherein the alias request includes at least the related e-mail address;
the processing device is further configured to identify the alias e-mail address associated with the related e-mail address; and
the transmitting device is further configured to transmit the identified alias e-mail address.

19. The system of claim 18, wherein the e-mail registration information is received from the processing device subsequent to identifying the alias e-mail address.

20. The system of claim 18, further comprising:
an e-mail database configured to store a plurality of unassigned e-mail addresses, wherein
identifying the alias e-mail address associated with the related e-mail address includes identifying, by the processing device, an unassigned e-mail address in the e-mail database.

21. The system of claim 20, wherein the processing device is further configured to remove, from the e-mail database, the identified unassigned e-mail address.

22. The system of claim 18, wherein identifying the alias e-mail address associated with the related e-mail address includes generating, by the processing device, the alias e-mail address using one or more address generation rules or algorithms.

23. The system of claim 22, wherein the generated alias e-mail address is based on the related e-mail address.

24. A system for automatic submission of an alias e-mail address, comprising:
a profile database configured to store an e-mail profile, wherein the e-mail profile includes data related to an e-mail address including at least the related e-mail address;
a receiving device configured to receive web page data for a web page, wherein the web page data includes a form comprised of at least one or more form fields, the one or more form fields including an e-mail field;
a processing device configured to automatically identify an alias e-mail address;
and
a transmitting device configured to
submit the form included in the web page data, wherein the e-mail field included in the one or more form fields includes the identified alias e-mail address, and
transmit at least the related e-mail address and alias e-mail address.

25. The system of claim 24, wherein the identified alias e-mail address is included in the e-mail field automatically by the processing device.

26. The system of claim 24, wherein the alias e-mail address is based on the related e-mail address.

27. The system of claim 24, wherein identifying the alias e-mail address includes
transmitting, by the transmitting device, an alias request, and
receiving, by the receiving device, the alias e-mail address.

28. The system of claim 24, further comprising:
an e-mail database configured to store a plurality of unassigned e-mail addresses, wherein
identifying the alias e-mail address associated with the related e-mail address includes identifying, by the processing device, an unassigned e-mail address in the e-mail database.

29. The system of claim 28, wherein the processing device is further configured to remove, from the e-mail database, the identified unassigned e-mail address.

30. The system of claim 24, wherein identifying the alias e-mail address includes generating, by the processing device, the alias e-mail address using one or more address generation rules or algorithms.
